(19) United States
(12) Patent Application Publication
(10) Pub. No.: US 2017/0249464 A1
(43) Pub. Date: Aug. 31, 2017

(54) METHOD FOR ENABLING SIMULTANEOUS CONTROL OF A PLURALITY OF TPMs AND RELATED COMPONENTS

(71) Applicant: TELEFONAKTIEBOLAGET LM ERICSSON (PUBL), Stockholm (SE)

(72) Inventor: Alexander Maximov, Lund (SE)

(21) Appl. No.: 14/653,259

(22) PCT Filed: May 28, 2015
(86) PCT No.: PCT/EP2015/061811

§ 371 Date: Jun. 17, 2015

(51) Int. Cl. G06F 21/57; G06F 21/44

(52) U.S. Cl. CPC G06F 21/57; G06F 21/44

(57) ABSTRACT

This disclosure provides a method for enabling or supporting simultaneous control of a plurality of TPMs. The plurality of TPMs comprises a first TPM and a second TPM. The method comprises obtaining from an application program an interface instance reference to an interface instance associated with the first TPM. The method comprises obtaining from the application program an application request. The application request comprises application request parameters and/or a function to be requested to the first TPM. The application request parameters comprise setup parameters indicative of the first TPM. The method comprises determining a type of the obtained application request. The type comprises a context initialization request or a function request. When it is determined that the type of the obtained application request corresponds to a context initialization request, the method comprises obtaining an instance context of the interface instance indicated by the interface instance reference and a trusted computing component, TCC, context associated with the application program; and transmitting the instance context and the trusted computing component context to the application program. When it is determined that the type of the obtained application request corresponds to a function request, the method comprises requesting, via the interface instance, the first TPM to perform the function, and/or computing an application response based on the application request parameters. The method comprises transmitting the application response to the application program.

### TECHNICAL FIELD

The present disclosure relates to platform security and in particular to a method for enabling simultaneous access and/or control of a plurality of trusted platform modules and related components.

### BACKGROUND

A Trusted Platform Module, TPM, is a hardware component that can perform a set of cryptographic algorithms. The specification of TPM is developed and published by the Trusted Computing Group, TCG. TPM hardware is nowadays included in personal computers, laptops and other devices. Also, there exist a number of emulated implementations of TPMs that are applied in, for example, so-called “virtual TPMs” in cloud computations.

TCG specification defines Trusted Core Services, TCS, application program interfaces, APIs that comprise more than 100 atomic commands to the physical TPM. On the physical level, the communication to a TPM can be described as just one function that sends a command buffer and receives another buffer as a command response. TCG also defines input and output, I/O, parameters for the TCS API and how each I/O parameters must be mapped to those commands and response blobs. Thus, a TCS stack needs to marshal and unmarshal those buffers in order to provide a convenient user-level API.

Most applications use a TPM through a library. TCG has defined the TCG Software Stack, TSS, for TPM (on top of TCS). There exists libraries under various licenses that implement TSS/TCS, and thus enable developers to develop their own software on top. TrouSerS is one of such libraries. The library can be mapped to a physical TPM. However, the library requires some adaptation to be mapped to an emulated TPM.

When multiple users or applications want to use one TPM, each application may open a new connection to the TPM and communicate to the same physical TPM. Thus, one TPM may support multiple connections for multiple applications.

A problem arises when a single application wants to manage and utilize at the same time multiple TPMs, especially at runtime and particularly when the TPMs are of various types. For example, an application may request to manage and use simultaneously a local physical TPM (e.g. that is installed on the motherboard), a software emulated TPM, and, possibly several remote TPMs that are accessible via an IP connection. Moreover, the number of multiple TPMs that the application wants to access may vary on runtime as well. Existing solutions such as Public Key Cryptography Standard #11, PKCS#11, which support abstract tokens, do not cover all functionalities of a TPM and are not readily adapted to support simultaneous access to multiple TPMs of various types.

U.S. Pat. No. 8,385,551 shows a system and method for managing trusted platform module keys utilized in a cluster of computing nodes. U.S. Pat. No. 8,385,551 is concerned with key migration where the local TPM agent in the active node automatically initiates a migration process for automatically migrating the backup copy of the TPM key to the at least one standby node. U.S. Pat. No. 8,385,551 does not address the issues related to accessing multiple TPMs.

US2006026418 shows a method, apparatus, and computer program product for implementing a trusted computing environment within a data processing system. The data processing system includes multiple different service processor-based hardware platforms. Multiple different trusted platform modules, TPMs, are provided in the data processing system. Each TPM provides trust services to only one of the service processor-based hardware platforms. Each TPM provides its trust services to only a portion of the entire data processing system. US2006026418 is not concerned with support for simultaneous access to multiple TPMs.

Hence, existing solutions prove inadequate in many ways and require substantive modifications.

### SUMMARY

An object of the present disclosure is to provide methods, trusted computing components, and interfacing components which seek to mitigate, alleviate, or eliminate one or more of the above-identified deficiencies in the art and disadvantages singly or in any combination.

This object is obtained by a method for enabling or supporting simultaneous control of a plurality of TPMs. The plurality of TPMs comprises a first TPM and a second TPM. The method comprises obtaining from an application program an interface instance reference to an interface instance associated with the first TPM. The method comprises obtaining from the application program an application request. The application request comprises application request parameters and/or a function to be requested to the first TPM. The application request parameters comprise setup parameters indicative of the first TPM. The method comprises determining a type of the obtained application request. The type comprises a context initialization request or a function request. When it is determined that the type of the obtained application request corresponds to a context initialization request, the method comprises obtaining an instance context of the interface instance indicated by the interface instance reference and a trusted computing component, TCC, context associated with the application program; and transmitting the instance context and the trusted computing component context to the application program. When it is determined that the type of the obtained application request corresponds to a function request, the method comprises requesting, via the interface instance, the first TPM to perform the function, and/or computing an application response based on the application request parameters. The method comprises transmitting the application response to the application program.

This disclosure permits simultaneous control of the plurality of TPMs by avoiding having a TCC with an internal global state and by separating the functionality and contexts on different levels (TCC context, instance context). The absence of a global shared state at TCC avoids the need for synchronization between multiple processes and threads at the TCC. The present disclosure provides an efficient technique for enabling control of a plurality of TPMs with a reduced code size, and an adaptive and scalable architecture.

According to some aspects, the step obtaining the instance context comprises requesting an instance context from the interface instance 110 using the setup parameters, and obtaining the requested instance context from the interface instance.

According to some aspects, the application request parameters further comprise initialization parameters and obtaining a trusted computing component context comprises generating the trusted computing component context based on the initialization parameters.

It is an advantage of the present disclosure that the TCC is configurable for each connection or access to a TPM and thus kept stateless (i.e. have no internal state) between connections. The present disclosure provides thus a technique based on context initializations that enables control to a plurality of TPMs, that may even be of different types, and allows for a lightweight, scalable and adaptive implementation of TPM control mechanisms.

There is also disclosed herein a trusted computing component, TCC. The TCC comprises: a processor, a memory, and a component interface operatively connected to an application program and to at least one of a plurality trusted platform modules, TPMs using an interface instance. The plurality of TPMs comprises a first TPM and a second TPM. The trusted computing component is configured to obtain from the application program an interface instance reference to the interface instance associated with the first TPM. The trusted computing component is configured to obtain an application request from the application program. The application request comprises application request parameters and/or a function to be requested to the first TPM. The application request parameters comprise setup parameters indicative of the first TPM. The trusted computing component is configured to determine whether the obtained application request is a context initialization request or a function request. When it is determined that the obtained application request is the context initialization request, the trusted computing component is configured to obtain an instance context of the interface instance indicated by the interface instance reference and a trusted computing component context associated with the application program; and to transmit the instance context and the trusted computing component context to the application program. When it is determined that the obtained application request is the function request, the TCC is configured to request, via the interface instance, the first TPM to perform the function, and/or to compute an application response based on the application request parameters. The TCC is configured to transmit the application response to the application program.

The object is furthermore obtained by a method performed in an interfacing component for enabling or supporting simultaneous control of a plurality of TPMs. The plurality of TPMs comprises a first TPM and a second TPM. The method comprises receiving from a trusted computing component a request to connect to the first TPM. The method comprises invoking an interface instance associated with the first TPM. The method comprises obtaining an instance context corresponding to the invoked interface instance 110. The method comprises receiving a command from a trusted computing component, the command comprising a function. The method comprises requesting the first TPM to execute the function by transmitting the command to the first TPM. The method comprises receiving a command response from the first TPM; and transmitting the command response to the trusted computing component.

The methods disclosed herein of the interfacing component allow the support of simultaneous access/control of a plurality of TPMs by having the interface instance configurable for each connection to one of the TPMs. The methods disclosed herein permits the TCC to be globally stateless.

This disclosure also relates to an interfacing component. The interfacing component comprises a processor, a memory, an interface operatively connected to a trusted computing component and to at least one of a plurality of trusted platform modules, TPMs. The interfacing component is configured to receive from the trusted computing component a request to connect to the first TPM, and to invoke an interface instance associated with the first TPM. The interfacing component is configured to obtain an instance context corresponding to the invoked interface instance. The interfacing component is configured to receive a command from the trusted computing component. The command comprises a function. The interfacing component is configured to request the first TPMs to execute the function, and/or compute a command response; and to transmit the command response to the trusted computing component.

This disclosure also relates to a network node comprising a trusted computing component according to any aspects of this disclosure.

This disclosure also relates to a user equipment comprising a trusted computing component according to any aspects of this disclosure.

This disclosure also relates to a network node comprising an interfacing component according to any aspects of this disclosure.

This disclosure also relates to a user equipment comprising an interfacing component according to any aspects of this disclosure.

In addition to the above methods, there is also provided herein computer programs comprising computer program code which, when executed in a component, causes the component, to execute methods according to the present teaching.

The computer programs, the trusted computing components and the interfacing components, the network nodes, the user equipments provide advantages corresponding to the advantages already described in relation to the method.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is a block diagram illustrating a system according to some aspects of the present disclosure.

FIG. 2 is a flowchart illustrating method steps performed in a trusted computing component according to some aspects of this disclosure.

FIG. 3 is a block diagram illustrating a trusted computing component according to some aspects of the present disclosure, a network node and a user equipment according to some aspects of the present disclosure.

FIG. 4 is a flowchart illustrating methods performed in an interfacing component according to some aspects of this disclosure.

FIG. 5 is a block diagram illustrating an interfacing component, a network node and a user equipment according to some aspects of the present disclosure.

FIG. 6 is a signaling diagram illustrating interactions between an exemplary application program, an exemplary trusted computing component and an exemplary interfacing component according to some aspects of this disclosure.

### DETAILED DESCRIPTION

The present teaching relates to enabling or supporting simultaneous access or control to of a plurality of trusted platform modules, TPMs. The present technique is applicable to any electronic system as well as any data processing system where there is a need to use, control or access a plurality of TPMs.

The various components referred to herein are according to different aspects implemented as, e.g., application-specific integrated circuit, ASIC, field-programmable logic array, FPGA, or general purpose processor.

As mentioned in the background section, many issues arise from supporting an application program in simultaneous control of a plurality of TPMs that may each be of a different type. State-of-the-art TPM techniques tend to present fundamental issues and/or are quite inefficient when scaled to a plurality of TPMs which may be of different types. To support simultaneous access to multiple TPMs of various types, PKCS#11 would require a quite extensive and permanent extension of the API on top of TSS/TCS for each type of TPM which would each include a huge TCS/TSS stack. Such approach is thus not efficiently scalable to multiple TPMs of various types and leads to a substantive increase in terms of code size. Another approach may involve a non-trivial and extensive modification of the existing libraries below TCS/TSS and a redesign of the internal state of the libraries, which may not even be possible.

Alternatively, one may create several builds of a TSS/TCS library, each mapped to a certain type of TPM. However, this would only allow the application to use the type of TPM that was selected to create the build since linking such two different libraries is highly likely to result in symbol collisions during linkage. An additional approach could be to modify a command function to the TPM into a pointer, which can be directed to different TPMs. However, such a modification would break the internal state of the library as the library is tightly coupled to exactly one instance of a TPM. Furthermore, such modification would not be efficient in case of a multi-threading process as each library call has to be serialized.

The present disclosure proposes to enable or support simultaneous control of a plurality of TPMs by identifying an interface instance to a TPM with an interface instance reference, and devising an instance context to each TPM, and initializing an interface instance and a trusted computed component (that corresponds to the library in the discussion above) using the interface instance reference, the instance context and a trusted computing component context. The trusted computing component or library is thus kept stateless. The application program holds the trusted computing component context and the instance context for function requests as well as setup parameters for the initialization phase. By splitting the contexts in different category, holding the context and other parameters in the application program and performing initializations, the trusted computing component or library is adaptable to various types of TPMs, thus supports simultaneous control of a plurality of TPMs that may be of various types. The present disclosure provides also an efficient and scalable solution to simultaneous control of a plurality of TPMs.

Aspects of the present disclosure will be described more fully hereinafter with reference to the accompanying drawings. The methods, trusted computing components, interfacing components and network nodes disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

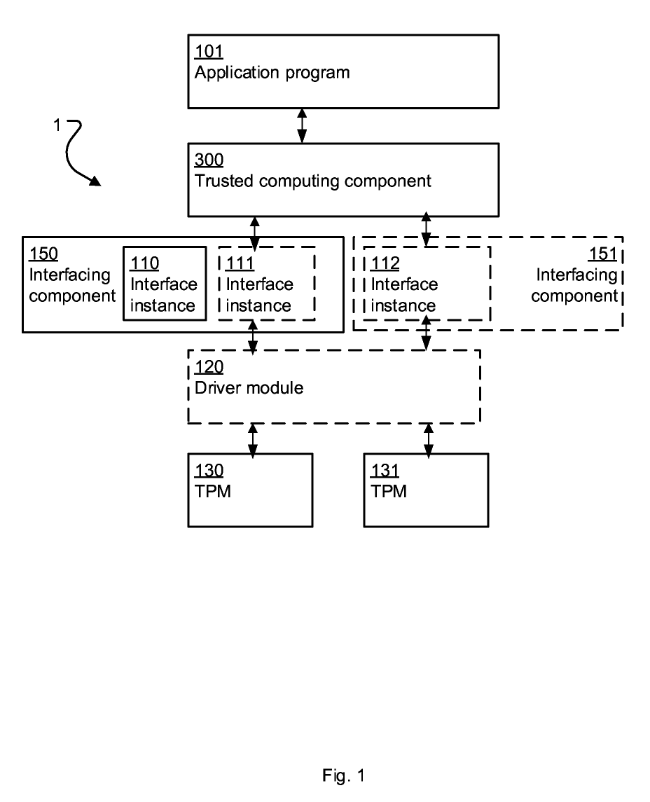

FIG. 1 shows a block diagram illustrating a system 1 according to some aspects of the present disclosure. The system 1 comprises an application program 101, a trusted computing component 300, an interfacing component 150, 151 and/or a trusted platform module 130, 131. The system 1 is for example a computing device or a user equipment, such as a personal computer, a laptop, a tablet, a personal digital assistant, PDA, a mobile device, and a network node such as a radio base station. The system 1 may correspond to a network node according to aspects of this disclosure, or a user equipment according to aspects of this disclosure. The term network node refers a device in a network, such as a radio base station, a femto base station, a core network node, a server node. It should be understood by the skilled in the art that “user equipment” is a non-limiting term which means any wireless device, terminal, or node capable of receiving and transmitting radio signals (e.g. PDA, laptop, mobile, sensor, fixed relay, mobile relay).

The application program 101 refers to a set of computer programs that use an underlying architecture (such as an operating system) to perform functions, tasks, or activities.

A TPM refers to a hardware or software component that is dedicated to provide trusted processing for TPM functionalities defined in TCG specifications, such as for security or cryptographic functions. The TPM 130, 131 may be of various types, such as a physical TPM, an emulated TPM, and a remote TPM, any of the previous types on a first operating system (such as Windows), and any of the previous types on a second operating system (such as Linux). Each type of TPM may support multiple TPM instances, such as multiple virtual TPMs. TPM may instantiate multiple TPM instances. In the remainder of this disclosure, the term “TPM” and “TPM instance” are interchangeable. A physical TPM is likely to be collocated in the same system or device as the application program and the TCC. A remote TPM is a TPM that is able to accept communication from a device comprising the application program and the TCC via a network or single-hop link. An emulated TPM is a software-based TPM that is executed on a data processor. A TPM may comprise a combination of different types TPMs, such as a combination of a physical TPM, a TPM emulator, and a remote TPM. The system 1 comprises a plurality of TPMs, such as a first TPM 130, a second TPM 131, a third TPM, a fourth TPM etc.. TPMs among the plurality of TPMs can be for example of the same type or of different types.

The trusted computing component 300 refers to a component that provides here a collection of resources to the application program 101 so as to support the application program to achieve certain tasks or functions. Examples of trusted computing component, TCC, are a component that provides or implements a library, such as a TPM library. The TPM library provides for example a collection of constant data, routines, subroutines, commands, structures, classes, values, and types specifications so as to access or control a TPM.

The application program 101 comprises a plurality of application programs according to some aspects. The application program 101 is operatively connected to the TCC 300. The application program 101 and the TCC 300 may be located in the same device. The TCC 300 is operatively connected to one or more interfacing components 150, 151. The interfacing component 150 and the TCC 300 are located in the same device or system according to some aspects. The interfacing component 150 comprises an interface instance 110 associated with one of the TPMs, 130, 131. According to some aspects, the interfacing component 150 comprises an additional interface instance 111 associated with one of the TPMs 130, 131. An interface instance refers to a process that interfaces a TPM.

According to some aspects, the TCC 300 is connected to an additional interfacing component 151 that comprises an interface instance 112 associated with one of the TPMs 130, 131 and that is connected to any one of the TPMs 130, 131.

The system 1 comprises a driver module 120 according to some aspects. The driver module 120 is for example a hardware component or a software component capable of operating, controlling, synchronization and/or serialization of incoming requests and/or interfacing another hardware or software component.

System 1 can be considered as an architecture including several layers. A top layer describes an application layer such as an application program. A following layer corresponds to the TCC 300 or a user's API (as a vector of functions or set of well-agreed methods) that enables support for multiple types of TPMs. A subsequent layer “Interface Instances” is capable of handling a connection to the TPMs. One interface instance is configured to be used to address multiple instances of TPMs that belong to the same type by using setup parameters that are instance-specific. A last layer corresponds to the interface to the TPM that is configured with the instance context and is able to provide a link between the application program and the requested TPM. This enables multiple application programs or users to connect to a single TPM instance.

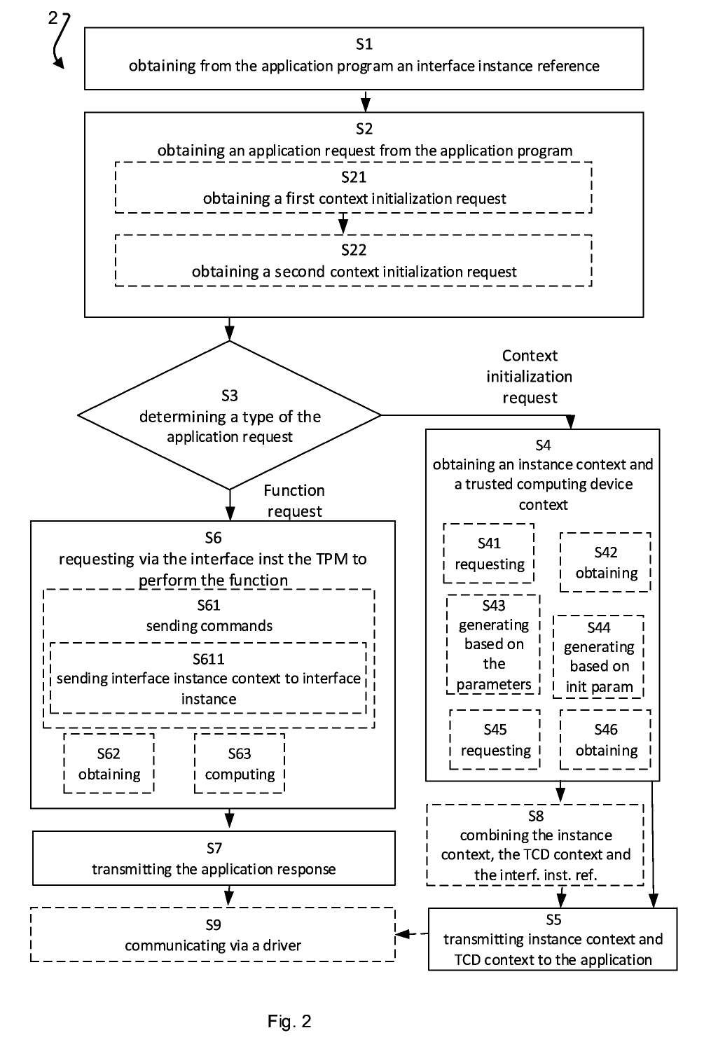

FIG. 2 shows a flowchart illustrating exemplary methods 2 performed in a trusted computing component according to some aspects of this disclosure. Method 2 is for enabling or supporting simultaneous control of a plurality of TPMs. The plurality of TPMs comprises a first TPM 130 and a second TPM 131. The method 2 comprises obtaining S1 from an application program 101 an interface instance reference to an interface instance 110 associated with the first TPM 130. An interface instance reference refers to a locator directing to the interface instance associated with a TPM. The interface instance reference uniquely identifies an interface instance. The interface instance reference refers to an interface instance (and/or a type of TPM), i.e. the interface instance reference indicates to the TCC how to connect to the interfacing device and how to select the interface instance within the interfacing device. Examples of interface instance reference comprise a name identifier, an IP address, a port number, a socket identifier, a pointer, a memory address and/or a device identifier on a bus. An interface instance maybe implemented in a form of a shared library, or be built in the application program. Different interface instances represent for example different types of TPMs. Thus this way the application program is capable of using multiple interface instances simultaneously and therefore of supporting multiple types of TPMs.

The method 2 comprises obtaining S2 from the application program 101 an application request. The application request comprises application request parameters and/or a function to be requested to the first TPM 130. The application request parameters comprise setup parameters indicative of the first TPM 130, such as indicative of the interface instance 110 associated with the first TPM 130. Setup parameters may be in form of a data structure. Setup parameters are for example different for different interface instances. Setup parameters are devised to support selection of a TPM, and communication to the selected TPM. Examples of setup parameters include IP address, port, security parameters (such as login, password, credential, and cryptographic algorithms indicators), configuration parameters, a TPM instance reference and/or a maximum response time for a command request. The setup parameters are devised by the application program 101 based on the interface instance selected by the application program 101. Stated differently, the setup parameters are instance specific data objects. The application program 101 sends for example the setup parameters in an application request as a second part of a context initialization request. According to some aspects, the setup parameters refer to different interface instances of the same TPM type. This way, configuration of the interface instance 110 based on the setup parameters makes it possible for the application to support multiple TPMs of a selected type of TPM. For example, some interface instance can be “a remote TPM via IP” and the setup parameters include IP and port parameters, thus, addressing to multiple remote TPMs (of the same type). Setup parameters comprise for example a chain of references that encode a path to a TPM, and that particular TPM may be located remotely, over a network. The path includes for example many gateways so that the path points out to a single, unique TPM that the application program targets for connection. The function to be requested to the first TPM 130 refers to a function, activity or tasks to be requested by the TCC 300, which requires for example one or more function requests from the TCC to the first TPM 130.

The method 2 comprises determining S3 a type of the obtained application request. The type comprises a context initialization request or a function request. For example, an application request comprises an index that indicates which operation to perform. For example, index=0 indicates a context initialization request and index≠0 indicates a function request. Depending on the type of application request (indicated by index zero or non-zero), the application program 101 provides different vector of inputs. A function request comprises for example requesting to close a connection to a TPM and to close associated contexts. The TCC and/or the interface instance detect for example that function among many of function requests and close contexts accordingly, returning empty contexts back to the application program.

When it is determined that the type of the obtained application request corresponds to a context initialization request, the method 2 comprises obtaining S4 an instance context of the interface instance 110 indicated by the interface instance reference and a trusted computing component, TCC, context associated with the application program 101; and transmitting S5 the instance context and the trusted computing component context to the application program 101. For example, the instance context and the interface instance 110 are associated with the first TPM and the application program. An additional application program is provided with a different instance context to the same TPM. Optionally, one application program is provided with two instance contexts from the same interface instance 110 but referring to two different TPMs 130, 131. The instance context binds or is associated with for example at least two of the following: interface instance, application program, TCC and TPM. The trusted computing component context binds or is associated with for example at least two of the following: interface instance, application program, TCC and TPM.

When it is determined that the type of the obtained application request corresponds to a function request, the method 2 comprises requesting S6, via the interface instance 110, the first TPM 130 to perform the function, and/or computing an application response based on the application request parameters, and possibly the instance context, and/or the TCC context. Requesting S6, via the interface instance 110, the first TPM 130 to perform the function comprises for example requesting a plurality of sub-functions to be performed so as to achieve the single function comprised in the application request. For example, when the TCC 300 determines the type of the application request as a function request, the TCC 300 requests, serves execution of the function comprised in the application request. Examples of function requests include reset, read Public Key, TakeOwnership, OwnerClear, Startup, etc . . . The function request comprises for example closing of the contexts. The function is understood by the interface instance and/or the TCC, and treated in a way known to the interface instance and/or the TCC, in order to release the context and possibly TPM resources associated to that context being closed. The function request comprises an instance context, a TCC context, an interface instance reference, and/or function request parameters according to some aspects. Function request parameters are function-specific, and used at the TCC level. Function request parameters depend on the type of function request that is called. For TakeOwnership function request, function request parameters comprise for example a new TPM owner's secret value, a new TPM's storage root key secret value, a Public RSA key of TPM's endorsement key. For OwnerClear( ) function request, function request parameters comprise for example the current TPM owner's secret value, that was used earlier in TakeOwnership( ). During such execution, the TCC 300 is capable of executing one or more functions on TPM to fulfill the application request. The TCC 300 for example sends a command to TPM via the interface instance and receives a command response from the TPM, and computes an application response based on the command response. Depending on the function request and possibly on the TCC context, the TCC 300 sends zero, one or a plurality of commands. Computing the application response is additionally performed for example based on the TCC context.

The method 2 comprises transmitting S7 the application response to the application program 101. The TCC 300 transmits the computed application response to the application program 101. This disclosure permits simultaneous control of the plurality of TPMs by avoiding having a TCC 300 with an internal global state and by separating the functionality and contexts on different levels (TCC context, instance context). The absence of a global shared state at TCC 300 makes it possible to avoid synchronization between multiple processes and threads at TCC 300 since there is no need for locks and semaphores (every process and thread just executes on its own context and local stack and heap). The interfacing device and the driver module may need the synchronization and locks.

According to some aspects, the step S4 of obtaining the instance context comprises requesting S41 an instance context from the interface instance 110 using the setup parameters, and obtaining S42 the requested instance context from the interface instance 110. The instance context is requested from the interface instance indicated by the interface instance reference and the setup parameters that are instance-specific.

According to some aspects, the application request parameters further comprise initialization parameters and obtaining S4 a trusted computing component context comprises generating S43 the trusted computing component context based on the initialization parameters. For example, the context initialization request comprises setup parameters, initializations parameters and/or an interface instance reference. The initialization parameters that are TCC specific include for example parameters to configure the channel, such as a bandwidth parameter, timeouts, a bus, a login, a password a client certificate, a client authentication and/or methods to send/receive data. TCC may be configured in such a way that it is accessibly only to authenticated users/applications and/or limit access to TCC functionality depending on the user/applications. This allows the TCC to be configurable for each connection or access to a TPM and thus kept stateless (i.e. have no internal state) between connections. The present disclosure provides thus a technique based on context initializations at the TCC and at the interface instance that enable control to a plurality of TPMs, that may even be of different types, and allows for a lightweight, scalable and adaptive implementation of TPM control mechanisms.

According to some aspects, the context initialization request comprises a first context initialization request for the trusted computing component initialization and a second context initialization request for the interface instance initialization. The first context initialization request comprises the initialization parameters and the second context initialization request comprises the setup parameters. According to some aspects, obtaining S2 the application request comprises obtaining S21 the first context initialization request from the application program 101, and then obtaining S22 the second context initialization request from the application program 101. For example, the TCC 300 receives the interface instance reference, the setup parameters and/or the initializations parameters in a single context initialization request, or in a multiple context initialization requests. The second context initialization request may precede the first context initialization request. For example, the TCC 300 transmits the received setup parameters to the interface instance indicated by the interface instance reference, and the interface instance returns to the TCC 300 an instance context associated with the interface instance, the corresponding TPM, and the application program requesting the connection, and/or the TCC. The instance context binds the selected (or selected type of) TPM via the indicated interface instance, and the selected TPM instance (via the content of the setup parameters). Different contexts represent different connections on the application layer, and thus different instance contexts support the scenario where multiple applications wants to use the same TPM—each application obtaining a dedicated instance context. The TCC context is associated with the application program. The interface instance reference, TCC context and the instance context are according to some aspects transmitted in one message.

According to some aspects, obtaining S4 a trusted computing device context comprises generating S44 the trusted computing device context based on the first context initialization request, such as based on the initialization parameters.

According to some aspects, obtaining S4 the instance context comprises requesting S45 an instance context from the interface instance 110 based on the second context initialization request, and obtaining S46 the instance context from the interface instance 110.

According to some aspects, requesting S6, via the interface instance 110, the first TPM 130 to perform the function comprises sending S61 one or more commands to the first TPM 130, 131 via the component interface operatively connected to the interface instance 110 indicated by the obtained interface instance reference; obtaining S62 a command response; and computing S63 the application response based on the command response. For example, sending S61 one or more commands to the first TPM 130 comprises sending S611 to the interface instance 110 the corresponding interface instance context when it is determined that the obtained application request is the function request. In other words, the command or function request comprises the interface instance context. According to some aspects, when it is determined that the obtained application request is the function request, the application request further comprises an instance context indicative of the corresponding first TPM 130 and the trusted computing component context associated with the application program 101. For example, during the execution of the function request, the TCC 300 serves the function request by making several requests to the selected TPM using the received interface instance reference and instance context. For each requests, the TCC 300 prepares an input TPM command blob (CmdBlob), sends CmdBlob to the interface (such as to interfacing component 150) and receives a response blob (RspBlob). The response blob is then used internally by TCC 300 in the execution flow of the function request, so that the application response to the application program may include only parts of the response blob RspBlob. The interface instance 151 is able to modify the content of the received instance context, while the TCC 300 is not aware of the instance context structure and cannot modify the instance context. TCC 300 is capable of modifying only the TCC context and of using the interface instance reference obtained. TCC 300 generates the application response of the function request execution and sends the application response back to the application program, together with a possibly updated TCC context and instance context. The TCC 300 waits then for the next application request. At the end of a session or connection to the TPM, the application program sends a function request to close the opened contexts, which can be viewed as one of the set of function requests provided by TCC.

According to some aspects, the method 2 further comprises combining S8 the instance context, the trusted computing component context and the interface instance reference into one single application context, such as in one message to the application program 101. For example, the application response comprises the instance context, and/or the trusted computing component context.

In an illustrative example where the present technique is applicable, during the context/connection opening or initialization, the application program 101 provides to the TCC 300 an interface instance reference for the interface instance associated with the TPM that it wishes to connect to as well as setup parameters that are instance specific. For example, the application program 101 is to open a connection to a remote TPM so the setup parameters comprise IP address of the remote TPM and the port number. The TCC 300 returns an instance context corresponding to the interface instance indicated by the reference. The application program 101 sends a function request to the TCC 300, the function request comprising the instance context, a function/command. The TCC 300 has its own TCC context. Closing the context or connection by the application program 101 can be viewed as disconnecting from the TPM and the TCC 300. This operation includes for example unloading keys and other credentials from the physical TPM that are related to the closing context, which may be performed below the interface instance, such as in a driver module 120. The following interface instances can be defined e.g.:
itpmdrv_tbs—interface instance that communicates with a physical local TPM in a first operating system (such as Windows)
itpmdrv_tddl—interface instance that communicates with the physical local TPM in a second operating system (such as Linux)
itpmdrv_tcpip—interface instance that communicates with a remote TPM driver via TCP/IP protocol or via a driver module addressed by IP address and port
itpmdrv_soft—interface instance that communicates with one or more software emulated TPMs

According to some aspects, the method 2 further comprises communicating S9 a function request to the first TPM via a driver module 120 associated to each one of the plurality TPMs 130, 131, via a driver module 120 associated to a selected type of TPMs, and/or via a driver module 120 associated to a group comprising various types of TPMs. An interface instance has for example its own global internal context, but is capable of forwarding the incoming requests further to a driver module 120, or another device such as a gateway or a proxy. The interface instance uses the setup parameters in order to choose the destination of possible further requests. For example, the setup parameters provide the interface instance with a TCP/IP address and a port of a remote TPM or a driver module that supports and executes TPM command. A purpose of the driver module 120 is for example to serialize and to synchronize multiple requests from multiple application programs and to possibly keep track and manage utilization of resources of each TPM (such as when an application program loses a connection). The driver module 120 is for example located close to the actual TPM instance(s) so that multiple applications can use the same TPM instance without having to synchronize with each other. The driver module 120 may have its own state which is related to the shared resources of a single or a plurality TPM instance that may be of different types.

According to some aspects, the method further comprising obtaining S1a from an application program 101 an additional interface instance reference to an additional interface instance 111 associated with the second TPM 131; and obtaining S2a from the application program 101 an additional application request, the additional application request comprising application request parameters indicative of the second TPM 131 and/or a function to be performed on the second TPM 131; and performing the steps S3 to S7 towards the second TPM 131 while the steps S3 to S7 are performed towards the first TPM 130. The application request parameters comprise setup parameters indicative of the second TPM 131. Stated differently, the method 2 allows simultaneous control of the first TPM 130, the second TPM 131, and any additional TPM. According to some aspects, the second TPM 131 is accessed by the application program 101 and/or by a plurality of application programs at the same time as the first TPM.

According to some aspects, the plurality of TPMs 130, 131 comprises one or more types of TPMs 130, 131. A type of TPM comprises a physical TPM, a remote TPM, an emulated TPM, and/or a virtual TPM.

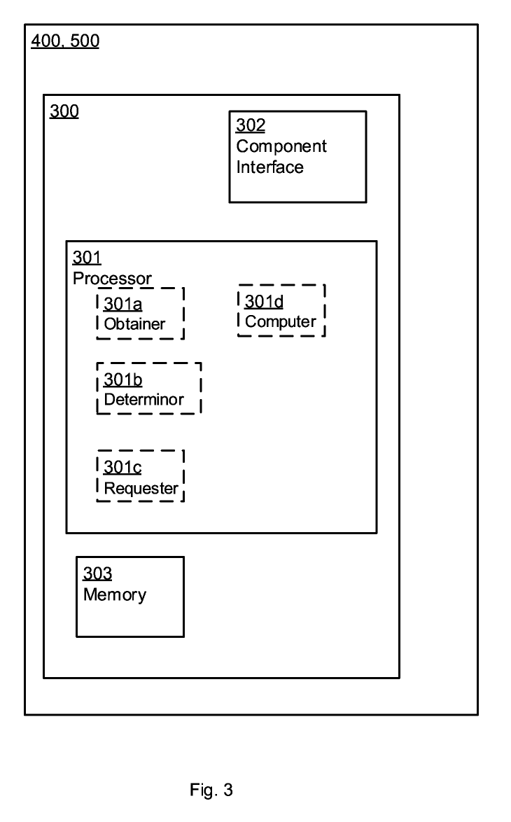

FIG. 3 shows a block diagram illustrating a trusted computing component 300, a network node 400 and a user equipment 500 according to some aspects of the present disclosure. The network node 400 comprises the trusted computing component 300 according to any aspects of this disclosure. The network node 400 is for example a radio base station, a relay node, a central ad hoc node, a server node and/or a core network node. The user equipment 500 comprises the trusted computing component 300 according to any aspects of this disclosure. The network nodes and user equipments disclosed herein are useful in virtual environment, for example, for debug and verification processes, or in a scenario when some operator wants to control and operate on physical TPMs installed on remote machines.

The trusted computing component, TCC, 300 comprises: a processor 301, a memory 303, and a component interface 302 operatively connected to an application program 101 and to at least one of a plurality trusted platform modules, TPMs 130,131 using an interface instance 110, 111. The plurality of TPMs comprises a first TPM and a second TPM. The memory 303 comprises for example collocated or remote data storage, Read Only Memory (ROM), and/or Random Access Memory (RAM). The trusted computing component 300 or the processor 301 is configured to obtain from the application program 101 an interface instance reference to the interface instance 110, 111 associated with the first TPM 130. According to some aspects, the TCC 300 or the processor 301 comprises an obtainer 301a configured to obtain from the application program 101 an interface instance reference. The trusted computing component 300 is configured to obtain an application request from the application program 101. The application request comprises application request parameters and/or a function to be requested to the first TPM 130. The application request parameters comprise setup parameters indicative of the first TPM 130. The trusted computing component 300 is configured to determine whether the obtained application request is a context initialization request or a function request. When it is determined that the obtained application request is the context initialization request, the trusted computing component 300 is configured to obtain an instance context of the interface instance 110 indicated by the interface instance reference and a trusted computing component, TCC, context associated with the application program; and to transmit the instance context and the trusted computing component context to the application program 101. Hence, according to some aspects, the TCC 300 or processor 301 comprises a determiner 301b configured to determine the type of the application request. The obtainer 301a is further configured, according to some aspects, to obtain an application request from the application program 101, and to obtain an instance context of the interface instance. According to some aspects, the interface 302 is configured to transmit the instance context and the trusted computing component context to the application program 101.

When it is determined that the obtained application request is the function request, the TCC 300 is configured to request, via the interface instance 110, the first TPM 130 to perform the function, and/or to compute an application response based on the application request parameters, and possibly based on the TCC context and the instance context. Hence, according to some aspects, the TCC 300 or the processor 301 comprises a requester 301c configured to request, via the component interface 302, the first TPM 130 to perform the function, and/or a computer 301d configured to compute an application response based on the application request parameters, and possibly based on the TCC context and the instance context. The TCC 300 or the processor 301 is configured to transmit the application response to the application program 101, such as via the component interface 302. For example, TCC 300 returns to the application program or client two contexts: the instance context and the TCC context that the application program may use in subsequent function requests. Alternatively or additionally, the TCC 300 returns one context that combines the instance context, the TCC context and the selected interface instance or interface instance reference.

According to some aspects, the trusted computing component 300 or the processor 301 is configured to obtain the instance context by requesting an instance context from the interface instance 110 using the setup parameters, and obtaining the requested instance context from the interface instance 110.

According to some aspects, the application request parameters comprise initialization parameters, and wherein the trusted computing component 300 or the processor 301 is configured to obtain the trusted computing component context by generating the trusted computing component context based on the initialization parameters. For example, multiple application programs may use TCC 300 simultaneously. For example, the TCC 300 is configured to have a TCC context and, therefore, during the context initialization request, the application program (or client) sends initialization parameters that are TCC-specific (such as library-specific) and the TCC 300 creates a new TCC context based on the initialization parameters. This makes it possible for multiple application programs to use the TCC 300 and permits the TCC 300 to be stateless between two requested connections.

According to some aspects, the context initialization request comprise a first context initialization request for the trusted computing component initialization and a second context initialization request for the interface instance initialization. The first context initialization request comprises the initialization parameters and the second context initialization request comprises the setup parameters. According to some aspects, the trusted computing component 300 is configured to obtain the first context initialization request from the application program 101, and then obtaining the second context initialization request from the application program 101.

According to some aspects, the TCC 300 is implemented in a form of a shared library, (such as .dll or .so files etc.), as an independent device or as a hardware module.

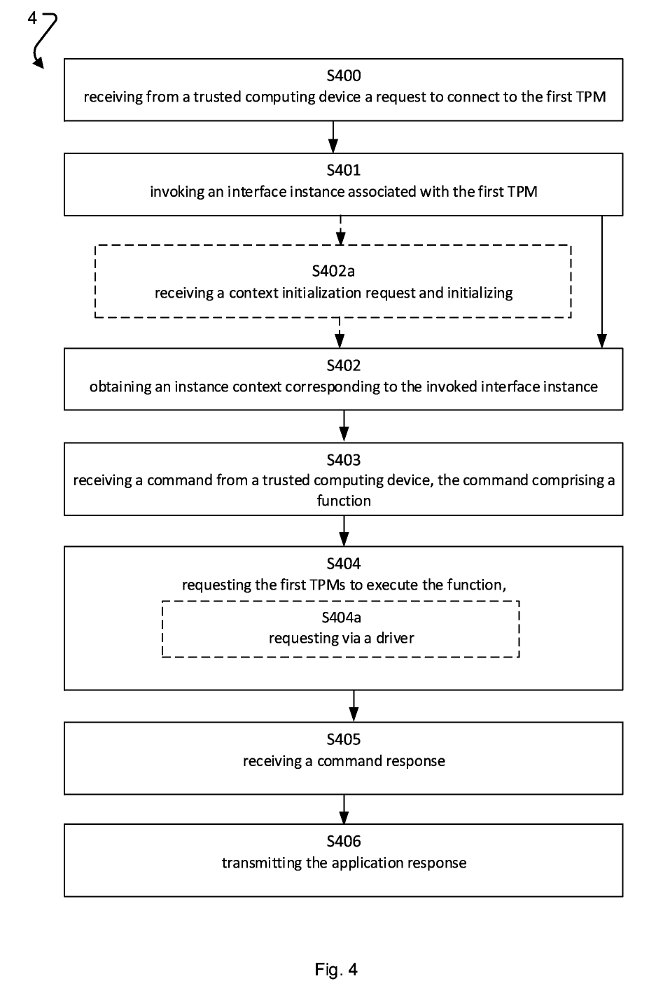

FIG. 4 shows a flowchart illustrating methods 4 performed in an interfacing component according to some aspects of this disclosure. Method 4 is for enabling or supporting simultaneous control of a plurality of TPMs 130, 131. The plurality of TPMs comprises a first TPM 130 and a second TPM 131. The method 4 comprises receiving S400 from a trusted computing component 300 a request to connect to the first TPM 130. The request comprises according to some aspects setup parameters indicating which TPM is targeted, and thus which interface instance to use. The method 4 comprises invoking S401 an interface instance 110 associated with the first TPM 130. The interfacing component 150 invokes the interface instance based on the interface instance reference corresponding to the first TPM that is given by the application program 101 via TCC 300, the interface instance being associated with the first TPM 130. The method 4 comprises obtaining S402 an instance context corresponding to the invoked interface instance 110. The instance context corresponds also to the first TPM 130. The interface instance is configured to support a plurality of TPMs of the same type and the instance context comprises parameters (among other parameters) indicative of a collection of TPMs that belongs to the same type. According to some aspects, the method 4 further comprises receiving S402a a context initialization request for the interface instance initialization; and initializing the invoked interface instance according to parameters comprised in the context initialization request, such as initializing a context of the interface instance according to the setup parameters. The method 4 comprises receiving S403 a command from a trusted computing component 300, the command comprising a function. The command comprises for example also the instance context. The command corresponds to the function request that the TCC 300 received from the application program 101. The method 4 comprises requesting S404 the first TPM 130 to execute the function by transmitting the command to the first TPM 130. Requesting S404 comprises for example generating a command blob to the first TPM 130 based on the received command and sending the command blob to the first TPM 130. According to some aspects, requesting S404 comprises requesting S404a via a driver module 120 the first TPM 130 to execute the function. The method 4 comprises receiving S405 a command response from the first TPM 130; and transmitting S406 the command response to the trusted computing component 300. The interfacing component 150 performing the methods 4 disclosed herein allows the support of simultaneous access/control of a plurality of TPMs by having the interface instance configurable based on the setup parameters for each connection to one of the TPMs. The interfacing component 150 performing the methods 4 disclosed herein permits the TCC 300 to be globally stateless.

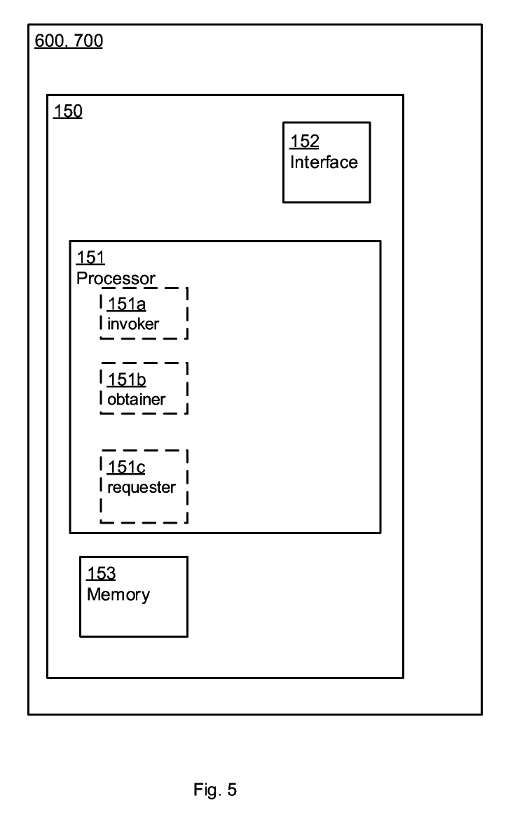

FIG. 5 shows a block diagram illustrating an interfacing component 150, a network node 600 and a user equipment 700 according to some aspects of the present disclosure. The network node 600 comprises the interfacing component 150 according to any aspects of this disclosure. The network node 600 is for example a radio base station, a relay node, a central ad hoc node, a server node and/or a core network node. The user equipment 700 comprises the interfacing component 150 according to any aspects of this disclosure.

The interfacing component 150 is configured to support simultaneous control of a plurality of TPMs, which may be of various types. The interfacing component 150 comprises a processor 151, a memory 153, an interface 152 operatively connected to a trusted computing component 300 and to at least one of a plurality of trusted platform modules, TPMs 130, 131. The memory 153 comprises for example collocated or remote data storage, Read Only Memory (ROM), and/or Random Access Memory (RAM). The interfacing component 150 or the processor 151 is configured to receive from the trusted computing component 300 a request to connect to the first TPM 130, such as via the interface 152. The request comprises according to some aspects setup parameters indicating which TPM is targeted, and thus which interface instance to use. The interfacing component 150 or the processor 151 is configured to invoke an interface instance 110 associated with the first TPM 130. The interfacing component 150 invokes the interface instance 110 based on the interface instance reference pointing to the first TPM that is given by the application program 101 via TCC 300, the interface instance being associated with the first TPM 130. According to some aspects, the interfacing component 150 or the processor 151 comprises an invoker 151a configured to invoke the interface instance 110. The interfacing component 150 or the processor 151 is configured to obtain an instance context corresponding to the invoked interface instance 110. According to some aspects, the interfacing component 150 or the processor 151 comprises an obtainer 151b configured to obtain an instance context corresponding to the invoked interface instance 110. The interface instance is configured to support a plurality of TPMs of the same type and the instance context comprises (among other parameters) also parameters indicative of collection of TPMs that belongs to the same type. According to some aspects, the processor 151 is further configured to receive a context initialization request comprising setup parameters for the interface instance initialization; and to initialize the invoked interface instance according to the setup parameters. The interfacing component 150 or the processor 151 is configured to receive a command from the trusted computing component 300, such as via the interface 152, the command comprising a function.

The interfacing component 150 or the processor 151 is configured to request the first TPM 130 to execute the function, and/or compute a command response; and to transmit the command response to the trusted computing component 300, such as via the interface 152. Hence the interfacing component 150 or the processor 151 comprises a requester 151c configured to request the first TPM 130 to execute the function and/or to compute a command response. According to some aspects, the processor 151 is configured to request the first TPM 130 to execute the function by generating a command blob to the first TPM 130 based on the received command and sending the command blob to the first TPM 130. According to some aspects, the interfacing component 150 or the processor 151 is configured to request via a driver module 120 the first TPM 130 to execute the function.

The network node 600 comprises the interfacing component 150 according to any aspects of this disclosure. The network node 600 is for example a radio base station, a relay node, a central ad hoc node, a server node and/or a core network node. The user equipment 700 comprises the interfacing component 150 according to any aspects of this disclosure.

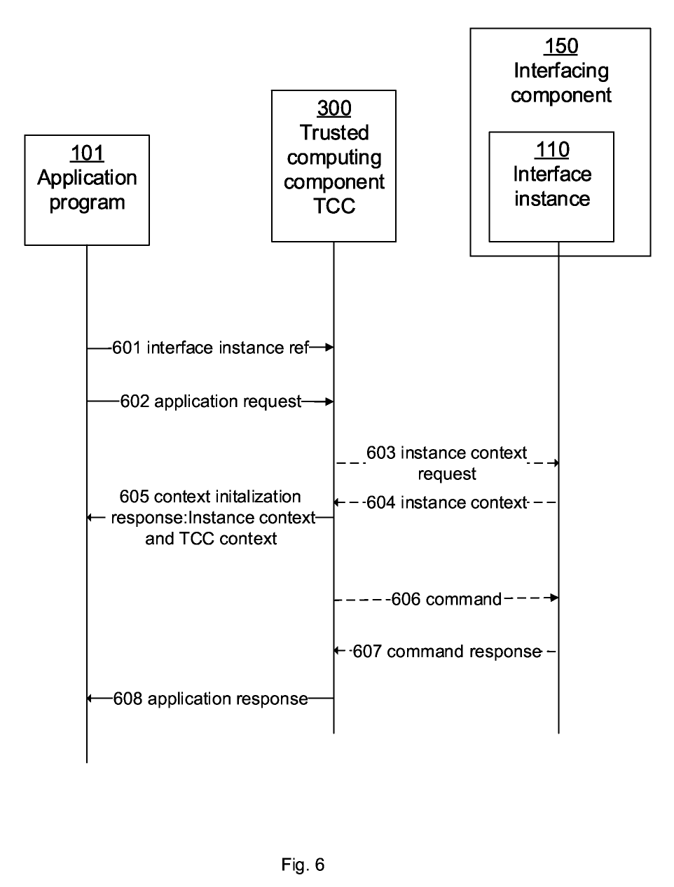

FIG. 6 shows a signaling diagram illustrating interactions between an exemplary application program, an exemplary trusted computing component and an exemplary interfacing component according to some aspects of this disclosure. The application program 101 initiates the connection to a first TPM via the trusted computing component 300 by transmitting the interface instance reference in a message 601 to the trusted computing component 300. The application program 101 sends then an application request 602 to the trusted computing component 300. The application request comprises setup parameters. The TCC 300 determines the type of the application request 602 by analyzing its content. When the TCC 300 determines that the application request 602 is a context initialization request, the TCC 300 obtains an instance context and generates a TCC context. Optionally, to obtain the instance context, the TCC 300 sends an instance context request 603 to the interfacing component 150 directed to the interface instance 110 indicated by the interface instance reference of message 601, the instance context request 603 comprising the setup parameters. The interface instance 110 returns the instance context in message 604 to the TCC 300. The TCC 300 generates a context initialization response 605, possibly as application response and sends it back to the application program 101. The context initialization response comprises for example the instance context and the TCC context. When the TCC 300 determines that the application request 602 is a function request (i.e. context initialization has been performed), the TCC sends one or more commands 606 corresponding to the function request, and receives a command response 607. The TCC 300 then generates an application response 608 based on the command response 607 and on application request parameters. The present disclosure provides an advantageous communication framework and protocol that is unified across TPM types and established by a trusted computing device.

It should be appreciated that FIGS. 1-6 comprises some modules or operations which are illustrated with a darker border and some modules or operations which are illustrated with a dashed border. The modules or operations which are comprised in a darker border are modules or operations which are comprised in the broadest example embodiment. The modules or operations which are comprised in a dashed border are example embodiments which may be comprised in, or a part of, or are further modules or further operations which may be taken in addition to the modules or operations of the darker border example embodiments. It should be appreciated that operations need not be performed in order. Furthermore, it should be appreciated that not all of the operations need to be performed. The example operations may be performed in any order and in any combination. It should be appreciated that the example operations of FIGS. 2 and 4 may be performed simultaneously for any number of components and apparatuses.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “components”, “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method, performed in a trusted computing component, for enabling simultaneous control of a plurality of trusted platform, modules (TPMs), the plurality of TPMs comprising a first TPM and a second TPM, the method comprising:
obtaining from an application program an interface instance reference to an interface instance associated with the first TPM;
obtaining from the application program an application request, the application request comprising application request parameters and/or a function to be requested to the first TPM, the application request parameters comprising setup parameters indicative of the first TPM;
determining (S3) a type of the obtained application request, the type comprising a context initialization request or a function request;
when it is determined that the type of the obtained application request corresponds to a context initialization request,
obtaining (S4) an instance context of the interface instance indicated by the interface instance reference and a trusted computing component context associated with the application program; and
transmitting (S5) the instance context and the trusted computing component context to the application program;
when it is determined that the type of the obtained application request corresponds to a function request,
requesting (S6), via the interface instance, the first TPM to perform the function, and/or computing an application response based on the application request parameters; and
transmitting (S7) the application response to the application program.

2. The method according to claim 1, wherein obtaining the instance context comprises requesting an instance context from the interface instance using the setup parameters, and obtaining the requested instance context from the interface instance.

3. The method according to claim 1, wherein the application request parameters further comprise initialization parameters, and wherein obtaining a trusted computing component context comprises generating the trusted computing component (TCC) context based on the initialization parameters.

4. The method according to claim 1, wherein the context initialization request comprises a first context initialization request for the TCC initialization and a second context initialization request for the interface instance initialization, and wherein the first context initialization request comprises the initialization parameters and the second context initialization request comprises the setup parameters, and wherein obtaining the application request comprises obtaining the first context initialization request from the application program, and then obtaining the second context initialization request from the application program.

5. The method according to claim 4, wherein obtaining a trusted computing device context comprises generating the trusted computing device context based on the first context initialization request.

6. The method according to claim 4, wherein obtaining the instance context comprises requesting an instance context from the interface instance based on the second context initialization request, and obtaining the instance context from the interface instance.

7. The method according to claim 1, wherein requesting, via the interface instance, the first TPM to perform the function comprises sending one or more commands to the first TPM via the component interface operatively connected to the interface instance indicated by the obtained interface instance reference; obtaining a command response; and computing the application response based on the command response, the instance context, and/or on the TCC context.

8. The method according to claim 7, wherein sending one or more commands to the first TPM comprises sending to the interface instance the corresponding interface instance context when it is determined that the obtained application request is the function request.

9. The method according claim 1, wherein when it is determined that the obtained application request is the function request, the application request further comprises an instance context indicative of the corresponding first TPM and the trusted computing component context associated with the application program.

10. The method according to claim 1, the method further comprising combining the instance context, the trusted computing component context and the interface instance reference into one single application context.

11. The method according to claim 1, wherein the application response comprises the instance context, and/or the trusted computing component context.

12. The method according to claim 1, the method further comprising communicating a function request to the first TPM via a driver module associated to each one of the plurality TPMs, associated to a selected type of TPMs, and/or associated to a group comprising various types of TPMs.

13. The method according to claim 1, the method further comprising obtaining from an application program an additional interface instance reference to an additional interface instance associated with the second TPM; and obtaining from the application program an additional application request, the additional application request comprising parameters indicative of the second TPM and/or a function to be performed on the second TPM; and performing the steps to towards the second TPM.

14. The method according to claim 1, wherein the second TPM is accessed by the application program and/or by a plurality of application programs at the same time as the first TPM.

15. The method according to claim 1, wherein the plurality of TPMs comprises one or more types of TPMs.

16. The method according to claim 1, wherein the type of TPMs comprises a physical TPM, a remote TPM, an emulated TPM, and/or a virtual TPM.

17. A method, performed in an interfacing component, for enabling simultaneous access to a plurality of trusted platform modules (TPMs), the plurality of TPMs comprising a first TPM and a second TPM, the method comprising:
receiving from a trusted computing component a request to connect to the first TPM;
invoking an interface instance associated with the first TPM;
obtaining an instance context corresponding to the invoked interface instance;
receiving a command from a trusted computing component, the command comprising a function;
requesting the first TPM to execute the function by transmitting the command to the first TPM;
receiving a command response from the first TPM; and
transmitting the command response to the trusted computing component.

18. The method according to claim 17, the method further comprising receiving a context initialization request for the interface instance initialization; and initializing the invoked interface instance according to parameters comprised in the context initialization request.

19. The method according to claim 17, wherein requesting comprises requesting via a driver module the first TPM to execute the function.

20. A trusted computing component comprising:
a processor;
a memory; and
a component interface operatively connected to an application program and to at least one of a plurality trusted platform modules (TPMs) using an interface instance, the plurality of TPMs comprising a first TPM and a second TPM;
wherein the trusted computing component is configured to:
obtain from the application program an interface instance reference to the interface instance associated with the first TPM;
obtain an application request from the application program, the application request comprising application request parameters and/or a function to be requested to the first TPM, the application request parameters comprising setup parameters indicative of the first TPM;
determine whether the obtained application request is a context initialization request or a function request;
when it is determined that the obtained application request is the context initialization request,
obtain an instance context of the interface instance indicated by the interface instance reference and a trusted computing component context associated with the application program; and
transmit the instance context and the trusted computing component context to the application program;
when it is determined that the obtained application request is the function request,
request, via the interface instance, the first TPM to perform the function, and/or compute an application response based on the application request parameters; and
transmit the application response to the application program.

21. The trusted computing component according to claim 20, wherein the trusted computing component is configured to obtain the instance context by requesting an instance context from the interface instance using the setup parameters, and obtaining the requested instance context from the interface instance.

22. The trusted computing component according to claim 20, wherein the application request parameters comprise initialization parameters, and wherein the trusted computing component is configured to obtain the trusted computing component context by generating the trusted computing component context based on the initialization parameters.

23. The trusted computing component according to claim 20, wherein the context initialization request comprise a first context initialization request for the interface instance initialization and a second context initialization request for the trusted computing component initialization, and wherein the first context initialization request comprises the setup parameters and the second context initialization request comprises the initialization parameters, and wherein the trusted computing component is configured to obtain the application request by obtaining the first context initialization request from the application program, and then obtaining the second context initialization request from the application program.

24. An interfacing component comprising:
a processor;
a memory;
an interface operatively connected to a trusted computing component and to at least one of a plurality of trusted platform modules (TPMs), wherein the interfacing component is configured to:
receive from the trusted computing component a request to connect to the first TPM;
invoke an interface instance associated with the first TPM;
obtain an instance context corresponding to the invoked interface instance;
receive a command from the trusted computing component, the command comprising a function;
request the first TPMs to execute the function, and/or compute a command response; and
transmit the command response to the trusted computing component.

25. The interface component according to claim 24, wherein the interfacing component is configured to initialize the invoked interface instance according to the setup parameters.

26. The interface component according to claim 24, wherein the interfacing component is configured to request via a driver module the first TPM to execute the function.

27. A network node comprising a trusted computing component according to claim 20.

28. A user equipment comprising a trusted computing component according to claim 20.

29. A network node comprising an interfacing component according to claim 25.

30. A user equipment comprising an interfacing component according to claim 25.

31. A nontransitory computer readable storage medium comprising a computer program product for supporting simultaneous access to a plurality of TPMs, the computer program product comprising program code, that, when executed on a trusted computing component, cause the trusted computing component to perform a method for enabling simultaneous control of a plurality of trusted platform modules (TPMs), the plurality of TPMs comprising a first TPM and a second TPM, the method comprising:
obtaining from an application program an interface instance reference to an interface instance associated with the first TPM;
obtaining from the application program an application request, the application request comprising application request parameters and/or a function to be requested to the first TPM, the application request parameters comprising setup parameters indicative of the first TPM;
determining a type of the obtained application request, the type comprising a context initialization request or a function request;
when it is determined that the type of the obtained application request corresponds to a context initialization request,
obtaining (an instance context of the interface instance indicated by the interface instance reference and a trusted computing component context associated with the application program; and
transmitting the instance context and the trusted computing component context to the application program;
when it is determined that the type of the obtained application request corresponds to a function request,
requesting, via the interface instance, the first TPM to perform the function, and/or computing an application response based on the application request parameters; and
transmitting the application response to the application program.

32. A nontransitory computer readable storage medium comprising a computer program product for supporting simultaneous access to a plurality of trusted platform modules (TPMs), the computer program product comprising program code that, when executed on an interfacing component, cause the interfacing component to perform a method for enabling simultaneous access to a plurality of trusted platform modules (TPMs), the plurality of TPMs comprising a first TPM and a second TPM, the method comprising:
receiving from a trusted computing component a request to connect to the first TPM;
invoking an interface instance associated with the first TPM;
obtaining an instance context corresponding to the invoked interface instance;
receiving a command from a trusted computing component, the command comprising a function;
requesting the first TPM to execute the function by transmitting the command to the first TPM;
receiving a command response from the first TPM; and
transmitting the command response to the trusted computing component.
